(19) United States
(12) Patent Application Publication
(10) Pub. No.: US 2026/0034467 A1
(43) Pub. Date: Feb. 5, 2026

(54) SYSTEMS AND METHODS FOR SHOW EFFECTS

(71) Applicant: Universal City Studios LLC, Universal City, CA (US)

(72) Inventor: Aaron Chandler Jeromin, Winter Garden, FL (US)

(21) Appl. No.: 19/279,825

(22) Filed: Jul. 24, 2025

Related U.S. Application Data
(60) Provisional application No. 63/676,141, filed on Jul. 26, 2024.

(51) Int. Cl. A63H 27/10; G06F 3/041

(52) U.S. Cl. CPC A63H 27/10; G06F 3/041

(57) ABSTRACT

Systems and methods may include a balloon with a circuit integrated within a surface of the balloon and coupled to one or more components to generate a show effect. The components may include an actuator, a magnet, a sensor, a light-emitting diode, a speaker, and so on. The circuit and the one or more components may also be communicatively coupled to a control system configured to instruct generation of a show effect based on touch sensor data from the sensor. For example, the control system may instruct the actuator to adjust a position and/or an orientation of a portion of the balloon, the magnet to attract or repel from another magnet, the light-emitting diode to emit light, the speaker to emit a sound, or any combination thereof.

### CROSS-REFERENCE TO RELATED APPLICATION

This application claims priority to U.S. Provisional Application No. 63/676,141, filed Jul. 26, 2024, entitled “SYSTEMS AND METHODS FOR SHOW EFFECTS,” the disclosure of which is incorporated by reference in its entirety for all purposes.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Throughout amusement parks and other entertainment venues, special effects can be used to help immerse guests in the experience of a ride or attraction. Immersive environments may include three-dimensional (3D) props and set pieces, robotic or mechanical elements, electrical or chemical elements, and/or display surfaces that present media. For example, an immersive environment may be provided via show components, such as balloons, to provide a show effect that facilitates an interactive experience for a guest. However, it is now recognized that current approaches for using a balloon to create show effects are limited. Thus, improvements for creating a show effect using a balloon are desired to provide a more realistic, suitable, and/or desirable interactive experience.

### SUMMARY

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In an embodiment, a balloon may include a sensor coupled to a surface of the balloon, where the sensor may generate touch sensor data. The balloon may also include a show effect component to generate a show effect based on the touch sensor data.

In an embodiment, a system may include a balloon, and a first show effect system coupled to the balloon, where the first show effect system includes a first body including a first circuit and a first magnet coupled to the first circuit. The system may also include a second show effect system coupled to the balloon. The second show effect system may include a second body having a second circuit and a second magnet coupled to the second circuit and configured to attract the first magnet.

In an embodiment, a system may include a balloon including a body, and the body may include a circuit and a sensor formed by at least a portion of the circuit and configured to generate touch sensor data. The system may also include a show effect component communicatively coupled to the circuit and a control system communicatively coupled to the circuit. The control system may instruct the show effect component to generate a show effect based on the touch sensor data.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram of a show effect system, in accordance with an aspect of the present disclosure;

FIG. 2 is a schematic diagram of the show effect system of FIG. 1, in accordance with an aspect of the present disclosure;

FIG. 3 is a schematic diagram of creating the show effect system of FIG. 1, in accordance with an aspect of the present disclosure;

FIG. 4 is a schematic diagram of the show effect system of FIG. 1 generating a show effect, in accordance with an aspect of the present disclosure;

FIG. 5 is a schematic diagram of multiple show effect systems of FIG. 1 generating a show effect, in accordance with an aspect of the present disclosure;

FIG. 6 is a schematic diagram of the show effect system of FIG. 1 generating a show effect, in accordance with an aspect of the present disclosure; and

FIG. 7 is a flowchart of an embodiment of a method for operating the show effect system of FIG. 1, in accordance with an aspect of the present disclosure.

### DETAILED DESCRIPTION

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The present disclosure is directed to providing show effects for an amusement or theme park. The amusement park may include a variety of features, such as rides (e.g., a roller coaster), theatrical shows, set designs, performers, and/or decoration elements, to entertain guests. Show effects may be used to supplement or complement the features, such as to provide the guests with a more immersive and/or unique experience. For example, the show effects may be presented to emulate real world elements in order to present a more realistic atmosphere for the guests.

Embodiments of the present disclosure are directed to a show effect system for presenting a show effect to create an immersive environment and/or entertainment for a guest. For example, the show effect system may include one or more components, such as a light emitting diode (LED), an actuator, a speaker, a microphone, a sensor, and so on, for generating a show effect based on a trigger. In certain instances, the trigger may include a touch, such as from a guest, and the show effect system may emit a sound in response to detecting the touch in a first portion (e.g., area, location, positions) of the show effect system. The show effect system may emit a light and/or a sound in response to detecting the touch in a second portion of the show effect system. The show effect system may adjust a position and/or an orientation of a third portion of the show effect system in response to detecting a continuous touch from the guest in a third portion of the show effect system. In another example, the trigger may include a signal from a controller to generate a show effect. The components of the show effect system may operate individually or in combination to generate the show effect. As such, the show effect system may provide an immersive experience and/or unique experience for the guest.

The show effect system may include a body with one or more metal layers that couple to a microcontroller and the one or more components. The microcontroller may include a collection of discrete electrical components or a single controller. For example, the microcontroller may include micro-electro-mechanical systems (MEMs), inertial measurement units (IMUs), and/or microcontroller units (MCUs). In another example, the microcontroller may include a mechanical spring element or tilt sensor coupled to one or more discrete electrical components that trigger an output (e.g., show effect.) For example, the show effect system may be fabricated (e.g., manufactured) from one or more metal (e.g., conductive) layers and one or more nonconductive layers that may be stacked on top of each other to form the body. Each metal layer may be etched with a portion of a circuit design, such as one or more traces, and sealed with a nonconductive (e.g., polymeric, plastic) layer. For example, each metal layer may include one or more traces that form the portion of a circuit. The layers may be stacked together to form the body of the show effect system. To facilitate communication between each of the metal layers, one or more vias may be fused into the metal layers to form electrical pathways between the metal layers. For example, one or more vias may form an electrical pathway from a first metal layer to a second metal layer. In other embodiments, conductive epoxy may be selectively applied at desired locations between the metal layers to form an electrical pathway between the metal layers. In certain instances, the components may be coupled to the body, such as positioned directly above or below the metal layers and coupled to the circuit formed by the metal layers. In other instances, the components may be integrated within the circuit, such as formed by a portion of the circuit. As such, a show effect system may be manufactured.

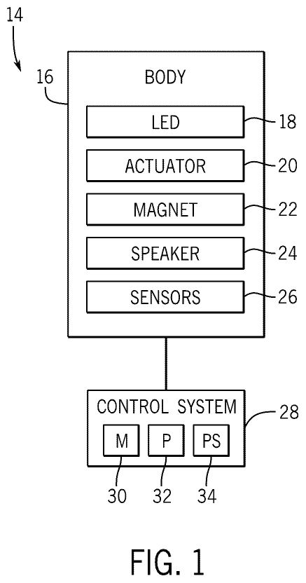

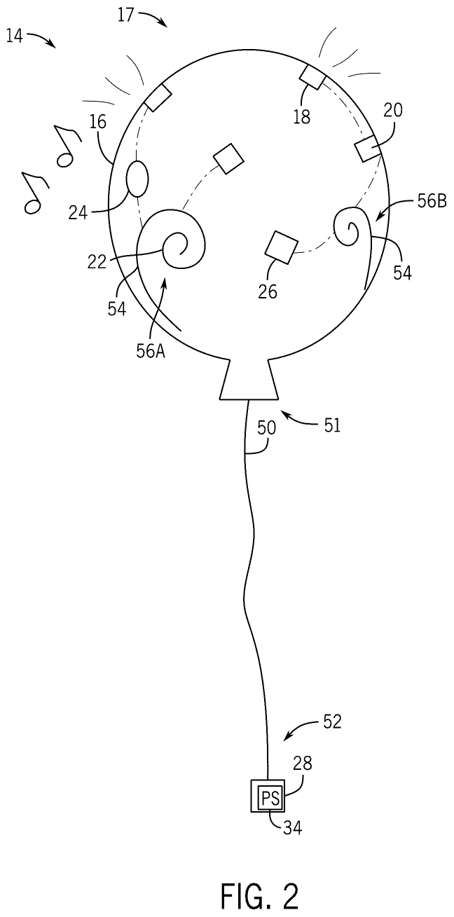

With the preceding in mind, FIG. 1 is a block diagram of an embodiment of a show effect system 14. The show effect system 14 may interact with a guest in an attraction system to provide an immersive and/or unique experience for the guest. For example, the show effect system 14 may provide show effects to the guest. To this end, the show effect system 14 may include a body 16 surrounding and/or integrated with one or more components, such as one or more light-emitting diodes (LEDs) 18, one or more actuators 20, one or more magnets 22, one or more speakers 24, one or more sensors 26, and the like. The show effect system 14 may be coupled, either physically coupled or wirelessly coupled, to a control system 28. In certain embodiments, the control system 28 may be positioned within a portion of the body 16. As will be further described with respect to FIG. 2, the show effect system 14 may include a circuit integrated within a first surface and/or a second surface of the body 16 that forms at least a portion of a component and/or couples to the component. For example, the sensor 26 and/or the magnet 22 may be integrated with the circuit, such as formed by a portion of the circuit. The sensor 26 may be formed by one or more sensor traces (e.g., metal traces) positioned across the across the body 16. The sensor traces may be directly integrated within the surface of the body 16 and/or include metal traces that generate and transfer sensor data to the control system 28. In another example, the LED 18 and/or the actuator 20 may couple to the circuit. The circuit may also be coupled to and/or include (e.g., integrated with) the control system 28, which transmits one or more signals to the components to generate the show effect. For example, the control system 28 may instruct the LED 18 to emit a light as the show effect and/or instruct the actuator 20 to cause a portion of the show effect system 14 to move and/or the LED 18 may emit light as the show effect. As such, the show effect system 14 may provide an immersive and/or unique experience for the guest.

The show effect system 14 may include one or more LEDs 18 for generating show effects. For example, the LED 18 may emit light as the show effect or at least a portion of the show effect. The LED 18 may emit the light once, may continuously emit the light in bursts, emit the light over a period of time, emit the light based on a pattern and/or a timing scheme, and so on. In some embodiments, the show effect system 14 may include multiple LEDs 18 that emit a respective color. For example, a first LED 18 may emit a red light and a second LED 18 may emit a blue light. The LED 18 may emit light in a pattern and/or a timing scheme. For example, the first LED 18 and the second LED 18 may alternate emissions such as the red light may be emitted for a period of time followed by the blue light being emitted for a period of time. Additionally or alternatively, the first LED 18 and the second LED 18 may emit the light at the same time. For example, the first LED 18 and the second LED 18 may be positioned adjacent to each other and create a purple light when emitting together. In another example, the first LED 18 and the second LED 18 may emit light at the same time in different directions to create a show effect.

In some embodiments, the show effect system 14 may also include one or more actuators 20 that may adjust a position and/or an orientation of a portion of the show effect system 14. For example, the actuator 20 may include a linear actuator, a rotation actuator, a cammed mechanical device, and so on. The actuator 20 may cause linear movement of a portion of the show effect system 14 in a direction, a rotational movement of a portion of the show effect system 14, and so on. By way of example, the body 16 may include a balloon in the form (e.g., shape) of a character and three actuators 20 disposed at different portions (e.g., positions) of the body 16. A first actuator 20 may be disposed at a first portion that corresponds to a head of the character, a second actuator 20 may be disposed at a second portion that corresponds to a first arm (e.g., right arm) of the character, and a third actuator 20 may be disposed at a third portion that corresponds to a second arm (e.g., left arm) of the character. The first actuator 20 may cause the head to move in a first direction, such as up and down to simulate the character nodding. In another example, the first actuator 20 may cause the head to rotate to simulate the character shaking their head. The second actuator 20 may cause the first arm to move between a first position and a second position, such as to simulate the character waving. In another example, the second actuator 20 may cause the first arm to move in a first direction and the third actuator 20 may cause the second arm to move in a second direction opposite the first direction, which may simulate the character clapping two hands together.

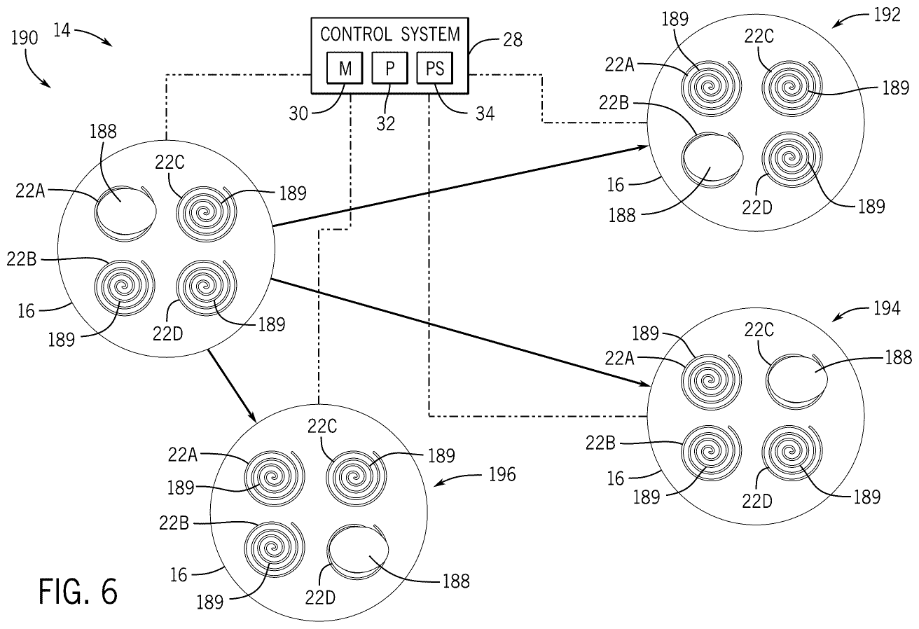

The show effect system 14 may include one or more magnets 22. The magnet 22 may include a permanent magnet that maintains a magnetic field, an electromagnet that may produce a magnetic field based on and/or when receiving a current, or any other suitable type of magnet. The magnetic field of the permanent magnet may remain the same, while a polarity and/or magnitude of the magnetic field of the electromagnet may be adjusted based on a direction and/or amount of current flowing through the electromagnet. For example, the magnet 22 may be a permanent magnet integrated within the body 16 of the show effect system 14. In another example, the magnet 22 may include an electromagnet formed by one or more coils within the circuit of the show effect system 14. The magnet 22 may be polarized by a current supplied to and/or running through the magnet 22 and/or the polarity of the magnet 22 may be changed or flipped by adjusting a direction of the current provided to and/or running through the magnet 22. Based on the polarity, the magnet 22 may attract or repel other magnets 22 and/or ferromagnetic metals that may be within the show effect system 14, other show effect systems 14, a component, or any combination thereof. To generate the show effect, the magnet 22 may attract and/or repel other magnets 22 within the show effect system 14 and/or within other show effect systems, thereby causing at least a portion of the show effect system 14 to move. For example, the show effect system 14 may include a first magnet 22 positioned within a first portion of the show effect system 14 and a second magnet 22 positioned within a second portion of the show effect system 14. The first magnet 22 may include a permanent magnet and the second magnet 22 may include an electromagnet. As further described with respect to FIG. 6, changing a polarity of the second magnet 22 may cause the magnets 22 to attract and/or repel from each other, which may cause the position of at least a portion of the show effect system 14 to be adjusted. For example, a first portion of the show effect system 14 may move in a vertical direction towards and/or away from the second portion based on the second magnet 22 attracting to and/or repelling from the first magnet 22. The movement of the first portion and the second portion towards and away from each other may be perceived as the show effect from the show effect system 14. In another example, the first magnet 22 and the second magnet 22 may include electromagnets. As such, adjusting the current provided to the first magnet 22 and/or the second magnet 22 may cause a polarity of the first magnet 22 and/or the second magnet 22 to change, which may cause the magnets 22 to attract and/or repel from each other

The show effect system 14 may include one or more speakers 24 to generate the show effect by emitting a sound. In certain instances, the speaker 24 may include a speaker component coupled to the circuit. In other instances, the speaker 24 may be formed by a portion of the circuit. Still in other instances, the speaker 24 may include a transducer device that generates a vibration of the balloon surface, thereby generating a sound from the surface of the balloon. For example, the speaker 24 may emit a word, multiple words, such as to form a sentence, a note, multiple notes, such as to form a portion of a song, animal sounds, nature sounds, and the like. In certain instances, the show effect system 14 may include a sensor 26 in the form of a microphone to receive sounds from the guest and the speaker 24 may emit (e.g., playback) the sounds from the guest to generate the show effect by playing back the sounds.

The show effects may be generated by a component or by multiple components of the show effect system 14. For example, the show effect system 14 may instruct the LED 18 to emit a light as the show effect. In another example, the show effect system 14 may instruct the LED 18 to emit a light and the speaker 24 to emit a sound as the show effect. Still in another example, the show effect system 14 may instruct the actuator 20 and/or the magnet 22 to adjust a position and/or an orientation of a portion of the show effect system 14, instruct the speaker 24 to emit a sound, and instruct the LED 18 to emit a light for a period of time as the show effect. As such, the show effect system 14 may provide an immersive and/or unique experience for a guest.

The show effect system 14 may include additional components or fewer components than described. For example, the show effect system 14 may also include infrared (IR) lights, Bluetooth components, haptics, scent generation (e.g., an ability to generate scents or odors), and the like to generate the show effect. In one embodiment, the show effect system 14 may include haptics that output a vibration to simulate a heartbeat as the show effect. In another example, the show effect system 14 may generate different scents as the show effect.

The show effect may be generated based on a trigger or indication. The trigger may include an indication of a touch from the guest (e.g., user) interacting with the show effect system 14 and/or an instruction from the control system 28 of the show effect system 14 to generate the show effect. For example, the guest may touch the show effect system 14 and the sensor 26 of the show effect system 14 may generate an indication of the touch. The sensor 26 may generate an indication (e.g., sensor signal, sensor data, touch sensor data) of an intensity, a pressure, a duration, a location (e.g., position), and the like of the touch. The show effect system 14 may determine a show effect for generation based on a location of the touch with respect to the show effect system 14 and/or a duration of the touch and instruct one or more components to generate the show effect.

One or more sensors 26 may be integrated and/or disposed within the body 16 of the show effect system 14. The sensor 26 may be formed by a portion of the circuit and/or coupled to the circuit of the show effect system 14. For example, the sensor 26 may include a capacitive touch sensor that detects a touch from the guest and generates a sensor signal and/or sensor data indicative of the touch. The sensor 26 may be formed by a portion of the circuit, which may be exposed on a surface of the body 16 of the show effect system 14 to detect the touch from the guest and transmit a sensor signal indicative of the touch. In another example, the circuit may be integrated within the body 16 and transmit a sensor signal (e.g., voltage signal) from one metal layer to another in response to detecting a touch from the guest. Additionally or alternatively, the sensor 26 may include a component coupled to the circuit and embedded within the body 16. For example, the sensor 26 may include a pressure (e.g., resistive) sensor that generates and/or transmits a sensor signal in response to detecting a touch and/or a pressure. In certain instances, the show effect system 14 may include multiple sensors 26 disposed at and/or integrated within different portions (e.g., locations, positions) of the body 16. In response to receiving a sensor signal from a respective sensor, the show effect system 14 may generate a respective show effect. For example, in response to receiving a trigger corresponding to a respective portion of the body 16, the show effect system 14 may identify and generate a corresponding show effect. For example, the body 16 may include a balloon in the shape of an animal and include two sensors disposed at different locations of the body 16. A first sensor 26 may be disposed at a first portion corresponding to a torso of the animal and a second sensor 26 may be disposed at a second portion corresponding to a head of the animal. In response to receiving a sensor signal from the first sensor 26, the show effect system 14 may generate a first show effect, such as by emitting a light and/or a sound. In response to receiving a sensor signal from the second sensor 26, the show effect system 14 may generate a second show effect different from the first show effect. The second show effect may include adjusting a position and/or orientation of the second portion of the body 16. Additionally or alternatively, the show effect system 14 may determine and/or generate the show effect based on the duration of the touch. For example, the show effect system 14 may emit a sound (e.g., note) as the show effect in response to receiving an indication of the guest briefly touching a portion of the body 16 and emit multiple notes, such as at least a portion of a song, in response to receiving an indication of the guest touching the portion for a period of time.

The show effect system 14 may receive instructions to generate a show effect. For example, the show effect system 14 and/or each component of the show effect system 14 may be communicatively coupled to the control system 28. The control system 28 may receive sensor data from the sensor 26 and transmit instructions to one or more components of the show effect system 14 to output (e.g., generate) a show effect. For example, the control system 28 may instruct the show effect system 14 to output a show effect based on a sensor signal and/or sensor data from the sensor 26 indicative of an intensity, a pressure, a duration, a location, and the like of a touch from the guest. In another example, the control system 28 may be communicatively coupled to multiple show effect systems 14 and transmit instructions to each show effect system 14 to output a show effect and/or show effects. For example, the show effect systems 14 may individually or collectively output a show effect as part of a parade or a show. In an embodiment, each show effect system 14 may include one or more antennas coupled to one or more transceivers to receive instructions from the control system 28. The transceivers may be wired together, wireless, or a combination thereof. For example, a transceiver of a show effect system 14 may wirelessly receive instructions from the control system 28. Additionally or alternatively, the show effect systems 14 may be communicatively coupled together to form a mesh network, a daisy chain, and the like to pass instructions from the control system 28 to other show effect systems 14. The show effect systems 14 may synchronously generate a show effect or asynchronously generate a show effect to provide an immersive and/or unique experience for the guest.

The control system 28 (e.g., an automated or programmable controller) may include a memory 30, processing circuitry 32, and a power source 34. The memory 30 may include volatile memory, such as random access memory (RAM), and/or non-volatile memory, such as read-only memory (ROM), optical drives, hard disc drives, solid-state drives, or any other non-transitory computer-readable medium that includes instructions to operate the show effect system 14. In addition, the memory 30 may store a lookup table including a relationship between one or more show effects and one or more guest interactions with the show effect system 14, such as an intensity, a pressure, a duration, and/or a location of a touch. For example, the relationship may associate a respective show effect with a touch in a respective position of the show effect system 14 and/or a duration of the touch. The relationship may be periodically updated and/or adjusted. The processing circuitry 32 may be configured to execute such instructions. For example, the processing circuitry 32 may include one or more application specific integrated circuits (ASICs), one or more field programmable gate arrays (FPGAs), one or more general purpose processors, or any combination thereof.

The control system 28 may be communicatively coupled to the LED(s) 18, the actuator(s) 20, the magnet(s) 22, the speaker(s) 24, and/or the sensor(s) 26. For example, the control system 28 may receive sensor data or a sensor signal (e.g., indicative of a touch from the guest) from the sensor 26 and instruct the LED 18, the actuator 20, and/or the speaker 24 to generate a show effect based on the sensor data. The control system 28 may determine a position (e.g., location) of the touch and/or the duration of the touch based on the sensor data and determine a corresponding show effect for generation. For example, the guest may touch a portion (e.g., position, location) of the show effect system 14. The sensor 26 may generate sensor data indicative of the touch and the control system 28 may receive the sensor data. The control system 28 may determine a location of the touch with respect to the show effect system 14 (e.g., based on where the sensor 26 is located) and may determine a show effect to output based on the location. Additionally or alternatively, the control system 28 may determine a duration of the touch and determine the show effect based on the duration. For example, the control system 28 may instruct the LED 18 to emit a light for a period of time in response to determining that the duration of the touch is greater than a threshold period of time. The period of time for the LED 18 to emit light may be similar and/or equivalent to the duration of the touch. In another example, the control system 28 may instruct the actuator 20 to adjust a position and/or orientation of at least a portion of the show effect system 14 and the speaker 24 to emit a sound for a period of time in response to determining that the duration of the touch is less than a threshold period of time. Additionally or alternatively, the control system 28 may set, adjust, and/or change one or more parameters of the show effects to adjust the appearance of the show effect by adjusting an output of the components. For example, the control system 28 may adjust a brightness of the light emitted, a length of the light emitted, a volume of the sound emitted, a frequency and/or speed of movement, and so on.

The power source 34 may be coupled to the components of the show effect system 14. For example, the power source 34 may include a battery or any suitable power source that provides power. In another example, the power source 34 may include solar cells or a solar panel. Still in another example, the show effect system 14 may include a connection to couple the show effect system 14 to an external power source (e.g., a mobile device, a wall outlet) to charge and/or provide power to the power source 34. In other instances, the mobile device (e.g., a cell phone, a smartphone, a wearable device, a computing device) may be the power source 34 to provide power to the components. For generation of the show effect, the power source 34 may provide power based on a pulse width modulation scheme. For example, the power source 34 may adjust the amount of current and/or the direction of current provided to and/or running through the magnet 22 (e.g., an electromagnet) to generate the show effect. The components of the show effect system 14 may be communicatively coupled (e.g., wired or wirelessly coupled) to the power source 34. For example, the components of the show effect system 14 may inductively receive power from a wireless power source (e.g., an inductive power source), receive power via radio frequency (RF) from a wireless power source (e.g., an RF power source), wirelessly receive power from a solar power source, receive power from a battery via a wire, and so on.

The show effect system 14 may include fewer or more components than illustrated. For example, the show effect system 14 may include antennas, radio frequency identification (RFID) chips, near-field communication (NFC) chips, infrared (IR) sensors, Bluetooth components, transceivers, and so on, to communicate with external communication devices. Moreover, the show effect system 14 may include haptics, scent generators, or other output devices to generate other show effects. For example, the show effect system 14 may communicate with a mobile device via the Bluetooth component and receive instructions to generate the show effects based on the instructions. As such, the show effect system 14 may provide an immersive and/or unique experience for the guest.

FIG. 2 is a schematic view of the show effect system 14. As illustrated, the body 16 may include a balloon 17 that provides show effects to a guest. The body 16 may include a surface surrounding and/or integrated with the components and/or a hollow interior that may be filled with a gas, such as air and/or helium, to cause the show effect system 14 to be buoyant. Due to the gas, the show effect system 14 may float above the ground but may be weighed down by the components and/or held down by the guest. As such, the show effect system 14 may not float away, such as in the case of a conventional helium balloon. The show effect system 14 may include a tether 50 (e.g., string) to be tethered to, coupled to, or held by the guest. As illustrated, a first end 51 of the tether 50 may couple to the body 16 of the show effect system 14, and a second end 52 of the tether 50 may couple to the control system 28. The tether 50 may be made from a polymeric material, such as plastic, and include one or more metal traces to form an electrical pathway between the control system 28 and the components of the body 16. For example, the tether 50 may provide the electrical pathways used to provide power from the control system 28 to the components, provide transmission of sensor data from the sensor 26 to the control system 28, provide transmission of instructions from the control system 28 to the components, and so on. In some embodiments, the power source 34 may provide power to multiple components via the tether 50. Although the illustrated control system 28 is positioned external to the body 16, in certain instances, the control system 28 may be positioned within the body 16 of the show effect system 14 and/or surrounded by the body 16.

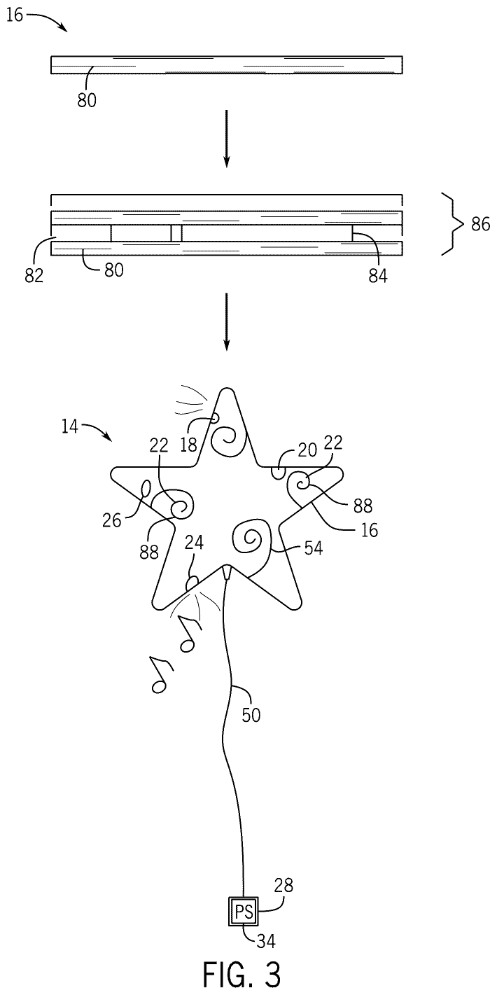

The body 16 of the show effect system 14 may include and/or surround the components, such as the LED(s) 18, the actuator(s) 20, the magnet(s) 22, the speaker(s) 24, the sensor(s) 26, and the like. The components may be integrated within the body 16 of the show effect system 14 and/or exposed on a surface of the body 16. For example, the LED 18 may be exposed on the surface of the body 16 and emit a light visible to the guest. In another example, the actuator 20 and/or the speaker 24 may be integrated within the body 16 and may not be visible to the guest. The components may be coupled to the circuit 54 and/or formed by the circuit 54. As further described with respect to FIG. 3, the body 16 may be formed by one or more metal layers that include one or more metal traces to form the circuit 54. A portion of the circuit 54 may form a component, such as the actuator 20, and hide the component from the view of the guest.

As discussed herein, the show effect system 14 may generate the show effect based on a trigger. The trigger may include an input, such as a touch or a sound, that may be detected by the sensor 26 and/or an instruction from the control system 28. By way of example, the guest may touch a first portion 56A of the body 16 and the sensor 26 may generate sensor data indicative of the touch. The control system 28 may receive the sensor data and determine the show effect based on the sensor data, such as the position of the first portion 56A with respect to the show effect system 14 and/or a duration of the touch. Additionally or alternatively, the control system 28 may determine the show effect based on a lookup table (LUT) storing a relationship between one or more show effects and one or more guest interactions. For example, the lookup table may indicate a first show effect based on the touch being in the first portion 56A, a second show effect based on the touch being in a second portion 56B, a third show effect based on the touch being less than a threshold period of time in the first portion 56A, a fourth show effect based on the touch being greater than a threshold period of time in the first portion 56A, and so on.

The control system 28 may determine that the guest touched the first portion 56A for a period of time. The control system 28 may determine the show effect for generation based on whether the period of time is less than a threshold period of time and the location being the first portion 56A. For example, the lookup table may indicate a show effect corresponding to a touch being less than a threshold period of time and the location being the first portion 56A may include a burst of light. As such, the control system 28 may instruct the LED 18 to emit a short burst of light. In another example, the control system 28 may determine that the guest touched the first portion 56A for a period of time greater than the threshold period of time, determine that the corresponding show effect may include a continuous emission of light based on the LUT, and generate the show effect by instructing the LED 18 to continuously emit light for a period of time. In certain instances, the control system 28 may instruct the LED 18 to emit light for as long as the sensor 26 detects a touch. In another example, the control system 28 may receive an indication of the guest touching the second portion 56B of the show effect system 14 from an additional sensor 26 disposed within the second portion. The control system 28 may determine the show effect based on the indication of the guest touching the second portion and the LUT. The LUT may indicate that the show effect may include adjusting a position and/or orientation of a portion of the show effect system 14 and/or the speaker 24 to emit a sound. As such, the control system 28 may instruct an actuator 20 to adjust a position and/or an orientation of a portion of the show effect system 14 and/or the speaker 24 to generate sound. In another example, the guest may speak into a microphone of the show effect system 14. The sensor 26, in the form of a microphone, may detect and receive sounds (e.g., speech, voice commands) of the guest and transmit the sounds as sensor data to the control system 28. The control system 28 may receive sensor data and generate a corresponding show effect by instructing the speaker 24 to play back a recording of the guest. The examples described above are merely illustrative, and it may be understood that the control system 28 may generate a variety of show effects, including but not limited to instructing the LED 18 to emit light, the speaker 24 to emit sound, the actuator 20 to adjust a position and/or orientation of a portion of the show effect system 14, or any combination thereof.

Although FIG. 2 illustrates one show effect system 14, in certain instances, multiple show effect systems 14 may individually and/or collectively generate the show effect. For example, the show effect systems 14 may be communicatively coupled to each other and/or the control system 28 and receive instructions to generate the show effect. The control system 28 may transmit instructions to a first show effect system 14 and the first show effect system 14 may transmit the instructions to one or more additional show effect systems 14 to generate respective show effects that may be combined together to form a larger show effect. The show effect system 14 may be configured to instruct other show effect systems 14 based on a timing scheme, a pattern, or the like. In another example, the show effect system 14 may respectively transmit instructions to other show effect systems 14 to generate the combined show effect, thereby providing a unique and/or immersive experience for the guest. In other embodiments, the show effect system 14 described herein may be integrated with and/or used within metallized clothing, metallized shopping bags, and the like. For example, the show effect system 14 may include a costume with the body 16 and one or more components that may be worn by an actor during a show and/or a parade and receive instructions to generate show effects.

FIG. 3 is a schematic diagram of one example of creating the show effect system 14. As discussed herein, the show effect system 14 may include the body 16 formed by one or more metal layers (e.g., conductive layers) 80 with a circuit 54 and/or one or more components. The body 16 may be made from a polymeric material (e.g., polyethylteraphalate, polyethylene terephthalate (PET), film, polyester, Mylar®) that may be conductive and/or incorporate metal components (e.g., metal traces). It may be understood that the metal layers (e.g., conductive layers) 80 may be made from any suitable conductive material and/or include any suitable number of metal traces 81. The metal layers 80 may be etched, such as by a laser, to form one or more metal traces 81 to form the circuit 54. In other instances, the metal layers 80 may be formed on nonconductive (e.g., plastic, polymeric) layers using a sputtering method.

To form the body 16, a metal layer 80 may be etched to form one or more metal traces 81. The metal layer 80 may be stacked with a nonconductive layer 82 to seal the metal traces 81 within the metal layer 80. In some embodiments, multiple metal layers 80 may be stacked with multiple nonconductive (e.g., plastic, nonconductive) layers in an alternating fashion. That is, the nonconductive layers may separate each of the metal layers 80. For example, the nonconductive layer 82 may be laminated to the metal layer 80 using heat. In certain embodiments, the nonconductive layer 82 may be coupled to the metal layer 80 prior to the etching. The laser etching may be set to an intensity to etch the metal layer 80 to form the metal traces 81 but not interact with the nonconductive layer 82. In this way, manufacturing operations may be improved and a number of steps performed by the manufacturer may be reduced.

The body 16 may be formed by stacking one or more metal layers 80 and one or more nonconductive layers 82, respectively, to form a set of stacked layers 86. For example, the set of stacked layers 86 may include alternating layers of the metal layers 80 and the nonconductive layer 82. To form electrical pathways electrically coupling each of the metal layers 80, vias 84 may be provided between respective nonconductive layers 82. The vias 84 may provide electrical pathways for signal transfer between two metal layers 80. For example, one or more vias 84 may extend from a first metal layer 80 through a first nonconductive layer 82 to a second metal layer 80 for signal transfer between the metal layers 80. Additionally or alternatively, one or more vias 84 may extend from the second metal layer 80 and a second nonconductive layer 82 to a third metal layer 80, thereby providing signal transfer between the second metal layer 80 and the third metal layer 80 as well as between the first metal layer 80 and the third metal layer 80. As such, the one or more vias 84 may extend from one metal layer 80 to another metal layer 80. By coupling together the metal traces 81 within each metal layer 80, a circuit 54 may be formed. In an embodiment, electrical pathways between the metal layers 80 may be formed by conductive epoxy selectively applied at certain locations between the metal layers 80.

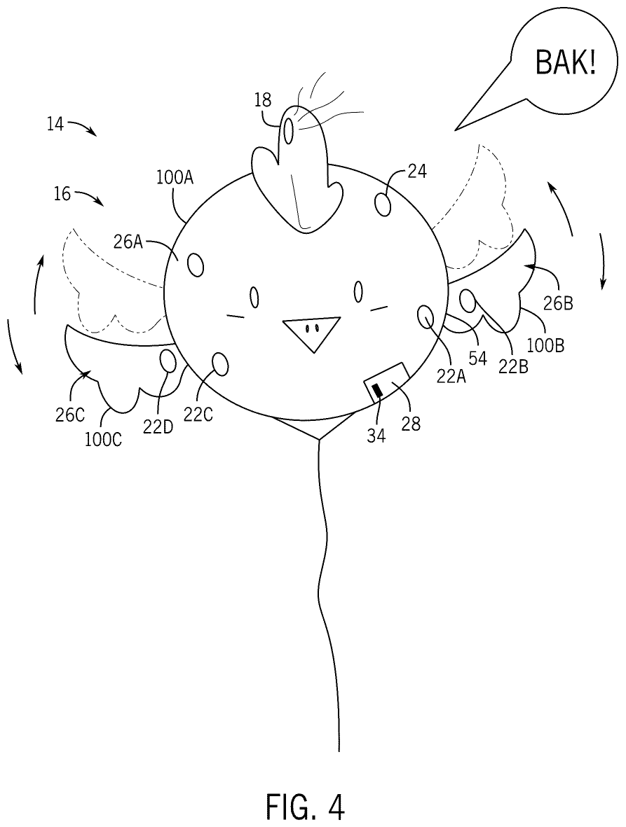

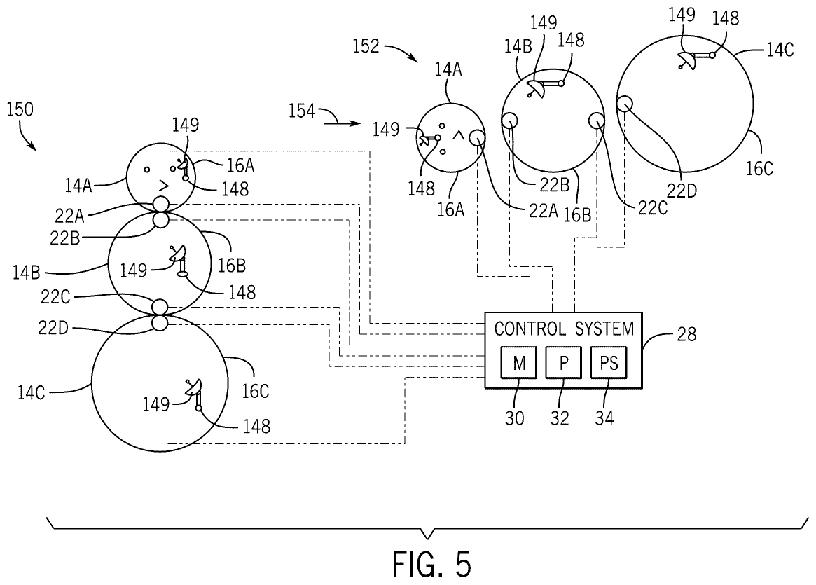

In certain instances, the body 16 may be formed by stamping the set of stacked layers 86 into a shape and/or a size. As illustrated, the body 16 may be in the form of a star. As illustrated with respect to FIG. 4, the body 16 may be in the form of a chicken, and as illustrated with respect to FIG. 5, the show effect system 14 may be in the form of a snowman. The body 16 may be formed by stamping a set of stacked layers 86 to form a hollow interior that may be filled with a gas. For example, the body 16 may be filled with a gas (e.g., helium, air). Accordingly, the show effect system 14 may be buoyant. Additionally or alternatively, the body 16 may include decorative elements, such as shapes, colors, patterns, and so on.

The body 16 may include the circuit 54 implemented by the fused stack of layers 86. The circuit 54 may be coupled to the power source 34 of the control system 28 and receive a current and/or voltage from the power source 34. Additionally or alternatively, the components may receive a current and/or voltage from the power source 34 via the circuit 54. For example, the components may be coupled to and/or implemented by the circuit 54 (e.g., by the metal traces 81 and/or vias 84). For example, the circuit 54 may include one or more coils 88 forming the magnet 22 (e.g., an electromagnet) that may adjust a magnetic field based on a current, thereby adjusting a position and/or orientation of a portion of the show effect system 14. In another example, the actuator 20 may be coupled to the circuit 54 to receive power and/or instructions from the control system 28 via the circuit 54. Additionally or alternatively, the LED 18, the speaker 24, and/or the sensor 26 may be formed by a portion of and/or coupled to the circuit 54.

FIG. 4 is a schematic diagram of an embodiment of the show effect system 14. As illustrated, the body 16 may include a balloon in the form of a chicken with adjustable wings. The body 16 may include a first portion 100A corresponding to the body of the chicken, a second portion 100B corresponding to a first wing of the chicken, and a third portion 100C corresponding to a second wing of the chicken. The show effect system 14 may include the LED(s) 18, the magnet(s) 22, the speaker(s) 24, and the sensor(s) 26. The sensor 26 may be integrated with the circuit 54 and exposed on a surface of the body 16 to receive a touch from the guest. For example, a portion of the exposed circuit 54 may be a capacitive circuit to detect a touch.

The show effect system 14 may generate a variety of show effects based on a location and/or a duration of the touch from the guest. As illustrated, the first portion 100A may include a first sensor 26A, the second portion 100B may include a second sensor 26B, and the third portion 100C may include a third sensor 26C. The control system 28 may determine a location of the touch based on a sensor signal from a respective sensor 26A, 26B, 26C (collectively 26). The control system 28 may also determine a duration of the touch based on the sensor data. Additionally or alternatively, the control system 28 may determine and instruct generation of the show effects based on a sound from the guest, an intensity of the touch, a pressure of the touch, and the like.

The control system 28 may receive a sensor signal from the first sensor 26A, determine the location of the touch to be in the first portion 100A, and instruct the LED 18 to emit light in response to determining that the location is the first portion 100A. The control system 28 may instruct the LED 18 to emit light in short bursts to appear as a blinking light. For example, the sensor 26 may detect the guest patting the head of the chicken and, the control system 28 may instruct the LED 18 to emit a red light as the show effect. In another example, the control system 28 may instruct the speaker 24 to emit a clucking or chirping sound in response to determining that the location is the first portion 100A and a duration of the touch may be greater than a threshold period of time.

In another example, the control system 28 may receive a sensor signal from the second sensor 26B and instruct the power source 34 to adjust a direction of current provided to at least one magnet 22. For example, the first portion 100A may include a first magnet 22A that may be a permanent magnet and the second portion 100B may include a second magnet 22B that may be an electromagnet, or vice versa. The second magnet 22B may be polarized by a current supplied to and/or running through the second magnet 22B and/or the polarity of the second magnet 22B may be changed or flipped by adjusting the direction of the current provided and/or running through the second magnet 22B. The first magnet 22A and the second magnet 22B may be positioned such that a magnetic field of the first magnet 22A overlaps and/or interacts with a magnetic field of the second magnet 22B. For example, the first magnet 22A and the second magnet 22B may attract to one another when the magnetic fields are of opposite polarities, thereby decreasing the distance between the second portion 100B towards the first portion 100A. The first magnet 22A and the second magnet 22B may repel from each other when the magnetic fields are of same polarities, thereby increasing a distance between the first portion 100A and the second portion 100B. The control system 28 may adjust a polarity of the magnetic field of the second magnet 22B by adjusting the current provided to the second magnet 22B. For example, the control system 28 may generate a show effect by adjusting the current provided to the second magnet 22B, thereby causing the first magnet 22A and the second magnet 22B to attract or repel from each other. In response to an indication of a location of the touch being in the second portion 100B, the control system 28 may instruct the power source 34 to adjust a direction and/or an amount of current provided to the second magnet 22B, thereby causing the second magnet 22B to attract and/or repel from the first magnet 22A. The attraction and/or repulsion between the first magnet 22A and the second magnet 22B may be perceived as a wing flapping. The frequency of the flapping may increase in response to an increased amount of current provided by the power source 34 to the magnet 22 and the frequency may decrease in response to a decreased amount of current provided.

In other instances, the first magnet 22A and the second magnet 22B may both be electromagnets and the control system 28 may adjust a polarity of the magnetic field of the first magnet 22A and/or the second magnet 22B to generate the flapping wing show effect. As illustrated, the show effect system 14 may also include a third magnet 22C coupled to the body 16 and a fourth magnet 22D coupled to a second wing. The third magnet 22C and/or the fourth magnet 22D may include permanent magnets or electromagnets. The control system 28 may adjust a polarity of the magnetic field of the third magnet 22C and/or the fourth magnet 22D in a similar manner as that of the first magnet 22A and/or the second magnet 22B to generate the show effect. Although the illustrated example of FIG. 4 includes magnets 22, in certain instances, the show effect system 14 may include one or more actuators 20 (FIG. 1) configured to adjust a position and/or orientation of the show effect system 14, such as the first wing or the second wing, to generate the flapping wing show effect.

It may be understood that the show effect system 14 may simultaneously or concurrently generate multiple show effects via one or more components, thereby providing entertainment to the guest. For example, the first sensor 26A may detect a touch in the first portion 100A and the second sensor 26B may detect a touch in the second portion. The control system 28 may instruct both the LED 18 to emit a light and the power source 34 to adjust the current provided to the second magnet 22B. In another example, the control system 28 may instruct the LED 18 to emit a light, the speaker 24 to emit a sound, and the power source 34 to adjust the current provided to at least one magnet 22 in response to determining a touch in the first portion 100A, a duration of the touch in the first portion 100A being greater than a threshold period of time, and a pressure of the touch being greater than a threshold pressure. As such, the show effect system 14 may generate one or more show effects based on an indication from the sensor 26.

FIG. 5 is a schematic diagram of multiple show effect systems 14 coupled together to generate a show effect. For example, two or more show effect systems 14 may be communicatively coupled to the control system 28 and receive instructions for generating the show effect. As illustrated, the control system 28 may communicatively couple to a first show effect system 14A, a second show effect system 14B, and/or a third show effect system 14C. To receive instructions from the control system 28, the show effect systems 14A, 14B, 14C (collectively 14) may each include a transceiver 148 and one or more antenna(s) 149, as may the control system 28.

As illustrated, the first show effect system 14A may include a body 16A formed in the shape of a head of the snowman, the second show effect system 14B may include a body 16B formed in the shape of a torso of the snowman, and the third show effect system 14C may include a body 16C formed in the shape of a base of the snowman. In certain embodiments, the illustrated first show effect system 14A, second show effect system 14B, and third show effect system 14C may each include different portions of one show effect system 14, such that one control system 28 may be shared by the portions.

The show effect systems 14 may include respective magnets 22A, 22B, 22C, 22D (collectively magnets 22) positioned at (e.g., disposed at) an end of the show effect system 14. The magnets 22 may be positioned within the show effect system 14 such that the magnets 22 may interact with a magnetic field of another magnet. The magnets 22 may be configured to attract and/or repel from other magnets 22, such as within other show effect systems 14. For example, the first show effect system 14A may include a first magnet 22A positioned at an end of the first show effect system 14A, the second show effect system 14B may include a second magnet 22B positioned at an end of the second show effect system 14B and a third magnet 22C positioned at an opposite end of the second show effect system 14B, and the third show effect system 14C may include a fourth magnet 22D positioned at an end of the third show effect system 14C. In certain instances, each show effect system 14 may include two magnets 22 positioned at opposite ends of the body 16. For example, each show effect system 14 may include two magnets 22, one magnet positioned at a first end of the body and another magnet positioned at a second, opposite end of the body. In other instances, the show effect systems 14 may include any suitable number of magnets 22 configured to attract to and/or repel from other magnets 22 within the respective show effect system 14 and/or other show effect systems 14.

In a first configuration 150, for example, the first magnet 22A of the first show effect system 14A may include a first polarity to attract to a second polarity of the second magnet 22B of the second show effect system 14B. For example, the control system 28 may instruct the power source 34 to provide current in a first direction to the first magnet 22A to cause generation of the first polarity and instruct the power source 34 to provide current in a second direction to the second magnet 22B to cause generation of the second polarity. The first polarity of the first magnet 22A may be different from the second polarity of the second magnet 22B. As such, the first show effect system 14A may couple to the second show effect system 14B. Similarly, the control system 28 may instruct the power source 34 to provide current in the first direction to the third magnet 22C of the second show effect system 14B to cause generation of the first polarity of the third magnet 22C and current in the second direction to the fourth magnet 22D to cause generation of the second polarity of the fourth magnet 22D. As such, the third magnet 22C may attract to the fourth magnet 22D. As such, the second show effect system 14B may couple to the third show effect system 14C via the third magnet 22C and the fourth magnet 22D. As such, the snowman may be formed by the show effect systems 14 to provide an immersive and/or unique experience to the guest.

The show effect systems 14 may generate a show effect by transitioning 154 from the first configuration 150 to a second configuration 152. For example, the show effect may be perceived as a snowman melting and/or falling apart. In the second configuration 152, the snowman appears to transition from a vertical configuration to a horizontal configuration, where the first show effect system 14A, the second show effect system 14B, and the third show effect system 14C may not be coupled to each other. To transition between the first configuration 150 and the second configuration 152, the control system 28 may instruct the power source 34 to adjust the current provided to one or more magnets 22. For example, the control system 28 may instruct the power source 34 to adjust the direction of the current provided to the second magnet 22B and/or the third magnet 22C to cause the second show effect system 14B to decouple from the first show effect system 14A and the third show effect system 14C. For example, the control system 28 may change and/or flip a polarity of the magnet 22 by adjusting the direction of the current provided to and/or running through the magnet 22. The control system 28 may instruct the power source 34 to change the direction of the current provided to the second magnet 22B and the third magnet 22C to adjust the second polarity of the second magnet 22B and the first polarity of the third magnet 22C, thereby causing the second magnet 22B to repel from the first magnet 22A and the third magnet 22C to repel from the fourth magnet 22D. In another example, the control system 28 may stop providing current to the magnets 22 to cause the magnets 22 (e.g., electromagnets) to stop generating an electric field. Without the current, the magnets 22 may not generate a magnetic field, and thus may not attract and/or repel from other magnets 22. As such, the control system 28 may cause two or more show effect systems 14 to decouple and generate the show effect of the snowman appearing to collapse. In other instances, the control system 28 may instruct the power source 34 to adjust a direction of the current provided to the first magnet 22A and/or the fourth magnet 22D to cause the show effect systems 14 to decouple. In certain instances, the control system 28 may instruct the power source 34 to adjust an amount of current provided to the magnets 22 to increase or decrease the attraction and/or repelling force. For example, increasing the amount of current provided to the magnets 22 may increase the repelling force between the magnets 22, thereby increasing a distance between the show effect systems 14.

The magnets 22 may include both electromagnets and permanent magnets. For example, the first magnet 22A of the first show effect system 14A may include a permanent magnet and the second magnet 22B of the second show effect system 14B may include an electromagnet. To couple the first show effect system 14A to the second show effect system 14B, the control system 28 may instruct the power source 34 to adjust the current provided to the second magnet 22B to cause the polarities of the second magnet 22B and the first magnet 22A to be different. For example, the control system 28 may associate and/or store an association of (e.g., in the memory 30) a first current direction of the second magnet 22B with the first configuration 150, and associate and/or store an association of (e.g., in the memory 30) a second current direction of the second magnet 22B with the second configuration 152. As discussed herein, the control system 28 may instruct the power source 34 to provide current in a first direction to the second magnet 22B to couple together the first show effect system 14A and the second show effect system 14B, thereby positioning the first show effect system 14A and the second show effect system 14B in the first configuration 150. To transition the show effect systems 14 to the second configuration 152, the control system 28 may instruct the power source 34 to provide current to the second magnet 22B in a second direction to adjust the polarity of the second magnet 22B and cause the second magnet 22B to repel from the first magnet 22A. The second direction may be opposite the first direction. Additionally or alternatively, the control system 28 may instruct the power source 34 to stop providing current to the second magnet 22B, which may reduce or eliminate the magnetic field generated by the second magnet 22B. As such, the first magnet 22A and the second magnet 22B may no longer attract to each other and the first show effect system 14A may decouple from the second show effect system 14B. As such, the control system 28 may transition the show effect systems 14 from the first configuration 150 to the second configuration 152.

FIG. 6 is a schematic diagram of the show effect system 14 generating a show effect. The show effect system 14 may include magnets 22A, 22B, 22C, 22D (collectively magnet 22) integrated within and/or exposed on a surface of the body 16 of the show effect system 14 and an additional component 188 to generate the show effect. For example, the additional component 188 may include a permanent magnet, and the first magnet 22A, the second magnet 22B, the third magnet 22C, and the fourth magnet 22D (collectively referred to herein as “magnets 22”) may include electromagnets. As illustrated, each magnet 22 may be formed by a coil 189 that may be adjacent to and/or exposed on a surface of the body 16. The magnet 22 may generate a polarity when receiving current in a first direction and may flip the polarity when receiving current in a second direction. The first direction may be opposite from the second direction. For example, the magnet 22 may cause current to travel in a clockwise direction and then cause current to travel in a counterclockwise direction. The magnets 22 may be communicatively coupled to the control system 28 and/or the power source 34 and configured to receive a current from the power source 34. For example, the control system 28 may instruct the power source 34 to provide a current to the first magnet 22A in a first direction to cause the first magnet 22A to generate a magnetic field. The control system 28 may instruct the power source 34 to provide the current to the first magnet 22A in a second direction to adjust the polarity of the magnet 22A. Additionally or alternatively, the control system 28 may instruct the power source 34 to stop providing current to the first magnet 22A to stop operation of the magnet 22.

The show effect may include the additional component 188 moving along the body 16 of the show effect system 14, such as transitioning from a first configuration 190 to a second configuration 192, a third configuration 194, or a fourth configuration 196. The example of FIG. 6 is merely illustrative, and it may be understood that the show effect system 14 may transition between the first configuration 190, the second configuration 192, the third configuration 194, and/or the fourth configuration 196 in any suitable manner based on instructions from the control system 28.

In the first configuration 190, the additional component 188 may attract to the first magnet 22A. The control system 28 may instruct the power source 34 to provide current to the first magnet 22A to cause the polarity of the first magnet 22A to be different from the polarity of the additional component 188. For example, the polarity of the first magnet 22A and the polarity of the additional component 188 may be opposite polarities. As such, the additional component 188 may attract to the first magnet 22A. Additionally or alternatively, the control system 28 may provide current to the second magnet 22B, the third magnet 22C, and/or the fourth magnet 22D in a second direction that may be opposite from the first direction to cause the polarities of the second magnet 22B, the third magnet 22C, and/or the fourth magnet 22D to be the same as the polarity of the additional component 188. As such, the second magnet 22B, the third magnet 22C, and/or the fourth magnet 22D may repel from the additional component 188. Additionally or alternatively, the control system 28 may not provide a current to the second magnet 22B, the third magnet 22C, and/or the fourth magnet 22D to reduce or eliminate potential attraction towards the additional component 188.

To transition from the first configuration 190 to the second configuration 192, the control system 28 may instruct the power source 34 to stop providing current to the first magnet 22A, which may reduce power consumption. As such, the first magnet 22A may not generate an electromagnetic field and may not attract to the additional component 188. Additionally or alternatively, the control system 28 may instruct the power source 34 to adjust the direction of the current provided to the first magnet 22, thereby causing the first magnet 22A to repel from the additional component 188. Concurrently, the control system 28 may instruct the power source 34 to provide current to the second magnet 22B in the first direction, thereby causing the additional component 188 to attract to the second magnet 22B.

To transition to the third configuration 194, the control system 28 may instruct the power source 34 to stop providing current to the first magnet 22A and concurrently instruct the power source 34 to provide current to the third magnet 22C. As such, the additional component 188 may attract to the third magnet 22C.

To transition to the fourth configuration 196, the control system 28 may instruct the power source 34 to stop providing current to the first magnet 22A and concurrently instruct the power source 34 to provide current to the fourth magnet 22D. The fourth magnet 22D may generate an electromagnetic field and/or a polarity opposite the polarity of the additional component 188. As such, the fourth magnet 22D may attract to the additional component 188. As such, the show effect system 14 may transition between the first configuration 190, the second configuration 192, the third configuration 194, and/or the fourth configuration 196.

From the guest's perspective, the show effect system 14 may appear as an eye, where the additional component 188 may appear as a pupil of the eye. The guest may perceive eye movement (e.g., pupil movement) as the additional component 188 transitions between the first configuration 190, the second configuration 192, the third configuration 194, and/or the fourth configuration 196. For example, as the additional component 188 transitions between the configurations 190, 192, 194, the guest may perceive the eye moving and/or rotating. The additional component 188 may appear (e.g., from the guest's perspective) to move in a circular manner, a square manner, in a random manner, or any combination thereof. For example, the additional component 188 may appear to spin as respective polarities of respective magnet 22 may be adjusted to selectively couple to the additional component 188.

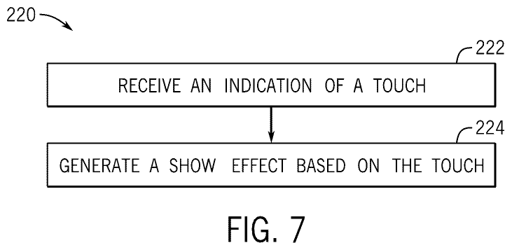

FIG. 7 is a flowchart of an embodiment of a method or process 220 for operating a show effect system. Any suitable device (e.g., the processing circuitry 32 of the control system 28 illustrated in FIG. 1) may perform the method 220. In one embodiment, the method 220 may be implemented by executing instructions stored in a tangible, non-transitory, computer-readable medium (e.g., the memory 30 of the control system 28). For example, the method 220 may be performed at least in part by one or more software components, one or more software applications, and the like. While the method 220 is described using steps in a specific sequence, additional steps may be performed, the described steps may be performed in different sequences than the sequence illustrated, and/or certain described steps may be skipped or not performed altogether.

At block 222, the control system 28 receives an indication of a touch. As discussed herein, the guest may touch the body 16 and the sensor 26 may receive and/or generate an indication of the touch. The sensor 26 may transmit the indication of the touch to the control system 28. In another example, the body 16 may include a circuit 54 configured for capacitive touch sensing. The circuit 54 may be exposed on a surface of the body 16, integrated within the body 16, or both. The circuit 54 may receive an indication of a touch from the guest and transmit the indication to the control system 28. Additionally or alternatively, the control system 28 may receive an indication of a sound from the guest via the sensor 26. The control system 28 may store the sound from the guest for the show effect.

At block 224, the control system 28 generates a show effect based on the touch. The control system 28 may determine a show effect for generation based on the indication of the touch from the sensor 26. For example, the control system 28 may determine the show effect for generation based on an intensity, a pressure, a duration, a location of the touch, and the like. The control system 28 may determine the show effect based on a lookup table stored in the memory 30. In response to determining the show effect, the control system 28 may instruct one or more components to generate the show effect. For example, the control system 28 may instruct the LED 18 to emit a light as the show effect, the actuator 20 to adjust a position and/or an orientation of a portion of the show effect system 14 as the show effect, the magnet 22 to attract and/or repel from another magnet 22 by adjusting a direction of current provided to the magnet 22 as the show effect, or any combination thereof. In another example, the control system 28 may instruct the speaker 24 to play back the sound received from the guest as the show effect. The control system 28 may determine a length (e.g., duration) of the show effect, an intensity of the show effect, a number of components to activate, or other attributes of the show effects based on the indication. As such, the show effect system 14 may provide an immersive and/or unique experience for the guest.

While only certain features of the disclosed embodiments have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A balloon comprising:
a sensor coupled to a surface of the balloon, wherein the sensor is configured to generate touch sensor data; and
a show effect component configured to generate a show effect based on the touch sensor data.

2. The balloon of claim 1, wherein the touch sensor data is indicative of a location of a touch with respect to the balloon or a duration of the touch.

3. The balloon of claim 1, comprising a control system communicatively coupled to the sensor and the show effect component and configured to determine the show effect for generation based on the touch sensor data.

4. The balloon of claim 3, comprising a tether configured to couple the balloon to the control system.

5. The balloon of claim 1, wherein the balloon comprises a body formed by at least one conductive layer coupled to at least one nonconductive layer, and wherein the at least one conductive layer comprises metal traces forming at least a portion of a circuit.

6. The balloon of claim 5, wherein the sensor and the show effect component are coupled to the circuit.

7. The balloon of claim 1, comprising a power source configured to communicatively couple to the show effect component and configured to provide current to the show effect component to cause the show effect component to generate a magnetic field.

8. The balloon of claim 7, wherein the show effect component is configured to attract an additional component based on the magnetic field.

9. The balloon of claim 7, wherein the show effect component is configured to repel an additional component based on the power source providing the current to the show effect component.

10. The balloon of claim 1, wherein the show effect component comprises a light emitting diode configured to emit a light based on the touch sensor data, a speaker configured to emit a sound based on the touch sensor data, a magnet configured to attract or repel from another magnet based on the touch sensor data, or any combination thereof.

11. A system comprising:
a balloon;
a first show effect system coupled to the balloon, the first show effect system comprising:
a first body comprising a first circuit; and
a first magnet coupled to the first circuit; and
a second show effect system coupled to the balloon, the second show effect system comprising:
a second body comprising a second circuit; and
a second magnet coupled to the second circuit and configured to attract to or repel from the first magnet.

12. The system of claim 11, wherein the first magnet comprises a permanent magnet and the second magnet comprises an electromagnet.

13. The system of claim 11, wherein the first show effect system comprises a first transceiver configured to receive first instructions from a control system and the second show effect system comprises a second transceiver configured to receive second instructions from the control system.

14. The system of claim 11, comprising a power source coupled to the first show effect system and the second show effect system, wherein the power source is configured to:
provide current to the second magnet to attract the first magnet to couple the first show effect system and the second show effect system; and
stop providing the current to the second magnet to decouple the first show effect system from the second show effect system.

15. The system of claim 11, comprising a power source coupled to the first show effect system and the second show effect system, wherein the first magnet and the second magnet are electromagnets, and wherein the power source is configured to:
provide current to the first magnet to generate a first magnetic field having a first polarity; and
provide current to the second magnet to generate a second magnetic field having a second polarity.

16. The system of claim 15, wherein the first polarity is different from the second polarity.

17. A system comprising:
a balloon comprising:
a body comprising a circuit;
a sensor formed by at least a portion of the circuit and configured to generate touch sensor data; and
a show effect component communicatively coupled to the circuit; and
a control system communicatively coupled to the circuit and configured to instruct the show effect component to generate a show effect based on the touch sensor data.

18. The system of claim 17, wherein the show effect component comprises a light emitting diode configured to emit a light based on the touch sensor data, a speaker configured to emit a sound based on the touch sensor data, a magnet configured to generate a magnetic field based on the touch sensor data, an actuator configured to adjust a position and/or an orientation of at least a portion of the body based on the touch sensor data, or any combination thereof.

19. The system of claim 18, wherein the control system is configured to:
instruct the light emitting diode to emit the light for a first period of time based on the touch sensor data indicating that a duration of a touch is greater than a threshold period of time; and
instruct the light emitting diode to emit the light for a second period of time based on the touch sensor data indicating that the duration of the touch is less than the threshold period of time.

20. The system of claim 17, comprising a power source coupled to the circuit and the control system, wherein the power source is configured to provide current to the show effect component and the sensor.
